(19) United States
(12) Patent Application Publication
(10) Pub. No.: US 2007/0230775 A1
(43) Pub. Date: Oct. 4, 2007

(54) Image processing apparatus and image processing method

(75) Inventors: Norimasa Ariga, Izunokuni-shi (JP); Hiroki Umezawa, Izunokuni-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushiki Kaisha Toshiba, Minato-ku (JP); Toshiba Tec Kabushiki Kaisha, Shinagawa-ku (JP)

(21) Appl. No.: 11/397,444

(22) Filed: Apr. 4, 2006

(51) Int. Cl. G06K 9/00

(52) U.S. Cl. 382/162

(57) ABSTRACT

An image processing apparatus comprising: a first color conversion table in which a relation in conversion from a color in a first color space to a color in a second color space is recorded; a second color conversion table in which a relation in conversion from a color in a third color space to a color in the second color space is recorded; a first color converting means for converting a color in the first color space into a color in the second color space; a gamut creating means for creating a gamut; a second color converting means for converting a color in the second color space into a color in the gamut; a color conversion table creating means for creating a third color conversion table; and a third color converting means for converting a color in the gamut into a color in the third color space.

### BACKGROUND OF THE INVENTION

1. Field of the Invention

The present invention relates to an image processing technology, particularly, an image processing apparatus and image processing method for creating a color conversion table including many relations between an input signal and an output signal to improve accuracy in color conversion.

2. Description of the Related Art

Color conversion is conventionally performed with color conversion data from a color space included in an image inputted by means of a digital camera or the like to a color space independent of devices such as a CIELAB and color conversion data from the color space independent of devices such as a CIELAB to a color space included in an output apparatus such as a printer. The CIELAB in the above context is a color space adopted by the CIE (Comission Internationale de l'Eclairage).

Concretely, image data inputted by means of a digital camera or the like is converted into color in the color space independent of devices with color conversion data corresponding to the inputted image, as shown in FIG. 1. As the color conversion data used in the above process, considered can be data for a matrix operation and a table for an interpolating calculation. The color converted with the color conversion data in the color space independent of devices is converted into a color material in a printing apparatus, namely, a color in a color space characteristic of an output apparatus for the purpose of printing by means of the output apparatus.

The ICC (International Color Consortium) proposes an ICC profile format relating to the color conversion, the format being applied a lot in an image pickup apparatus, an OS of a computer, an application, an output device and such.

The color conversion table used in color conversion such as the ICC profile format is a gathering of data of points (grid points) provided at even intervals in the color space independent of devices. Ranges of L*=0 to 100, a*=−128 to 127, and b*=−128 to 127 in the CIELAB space are divided to create the table.

In FIG. 3, a numeral 32 denotes a table created by dividing the CIELAB space.

A color space (gamut) 33 in which an output apparatus such as a printer can carry out printing, however, is only a part of the color conversion table 32 as shown in FIG. 3 and the most part of the color conversion table 32 is a useless space. Concretely, the number of grids of the whole color conversion table 32 is 4913 while the number of grids of the gamut 33 is 572. The size of the gamut 33 is thus just over 10% of that of the color conversion table 32.

Accordingly, the conventional color conversion table 32 used in color conversion such as the ICC profile format has a problem that the accuracy in color conversion in the gamut 33 is low for the data size of the color conversion table 32.

In view of the above, Patent Reference 1 (JP-A-2001-169126) has been conventionally opened to the public.

A method for referring disclosed in Patent Reference 1 is a method of defining in advance a color space of image data to be inputted to increase the number of grid points in a gamut for the purpose of obtaining a highly accurate result of calculation for the equal size of table.

The method for referring disclosed in Patent Reference 1, however, is a method of defining in advance a color space of image data to be inputted to increase the number of grid points in a gamut. Accordingly, various kinds of color spaces of image data to be inputted are used in the method for referring disclosed in Patent Reference 1. This is not effective since a user cannot define in advance the color space of image data these days.

In other words, sRGB, AppleRGB produced by Apple, AdobeRGB produced by Adobe and such are used for the color space of image data to be imputed nowadays, and therefore, it is difficult to define in advance the color space of the image data to be inputted.

Further, some color spaces are automatically selected in accordance with an image pickup apparatus, an operation system of a computer or an application. In this case, it is substantially impossible for a user to define in advance the color space of image data to be inputted.

Accordingly, the method for referring disclosed in Patent Reference 1 has a problem that a highly accurate result of calculation sometimes cannot be obtained.

### SUMMARY OF THE INVENTION

In view of the above, an object of the invention is to create a color conversion table including many relations between an input signal and an output signal to improve accuracy in color conversion.

In order to achieve the above object, the image processing apparatus in accordance with the invention is an image processing apparatus comprising: a first color conversion table in which a relation in conversion from a color in a first color space formed dependently on an inputted image to a color in a second color space formed independently of devices is recorded; a second color conversion table in which a relation in conversion from a color in a third color space formed dependently on an output device to a color in the second color space is recorded; a first color converting means for converting a color in the first color space into a color in the second color space on the basis of the first color conversion table; a gamut creating means for creating a gamut of the output device in the second color space on the basis of the second color conversion table; a second color converting means for converting a color in the second color space into a color in the gamut in accordance with gamut mapping using the gamut; a color conversion table creating means for creating a third color conversion table created by reversely converting the second color conversion table, the third color conversion table wherein a relation in conversion from a color in the second color space to a color in the third color space is recorded, the third color conversion table including a fourth color space in the shape of a rectangular parallelepiped including the gamut so that an outer surface of the gamut would inscribe the rectangular parallelepiped, the fourth color space being formed independently of devices; and a third color converting means for converting a color in the gamut included in the fourth color space into a color in the third color space on the basis of the third color conversion table.

Further, in order to achieve the above object, the image processing method in accordance with the invention is an image processing method comprising: a first color converting step for converting, on the basis of a first color conversion table in which a relation in conversion from a color in a first color space formed dependently on an inputted image to a color in a second color space formed independently of devices is recorded, a color in the first color space into a color in the second color space; a gamut creating step for creating, on the basis of a second color conversion table in which a relation in conversion from a color in a third color space formed dependently on an output device to a color in the second color space is recorded, a gamut of the output device in the second color space; a second color converting step for converting a color in the second color space into a color in the gamut in accordance with gamut mapping using the gamut; a color conversion table creating step for creating a third color conversion table created by reversely converting the second color conversion table, the third color conversion table wherein a relation in conversion from a color in the second color space to a color in the third color space is recorded, the third color conversion table including a fourth color space in the shape of a rectangular parallelepiped including the gamut so that an outer surface of the gamut would inscribe the rectangular parallelepiped, the fourth color space being formed independently of devices; and a third color converting step for converting a color in the gamut included in the fourth color space into a color in the third color space on the basis of the third color conversion table.

### BRIEF DESCRIPTION OF THE DRAWINGS

FIG. 1 is a schematic block diagram of a printing system including an image processing apparatus in accordance with the invention;

FIG. 2 is a functional block diagram of an image processing apparatus in accordance with the invention;

FIG. 3 is a perspective view illustrating a relation of plural color spaces existing in a color space formed independently of devices; and

FIG. 4 is a flowchart showing an operation of an image processing apparatus in accordance with the invention.

### DETAILED DESCRIPTION OF PREFERRED EMBODIMENTS

Embodiments of an image processing apparatus in accordance with the invention will be described with reference to the attached drawings.

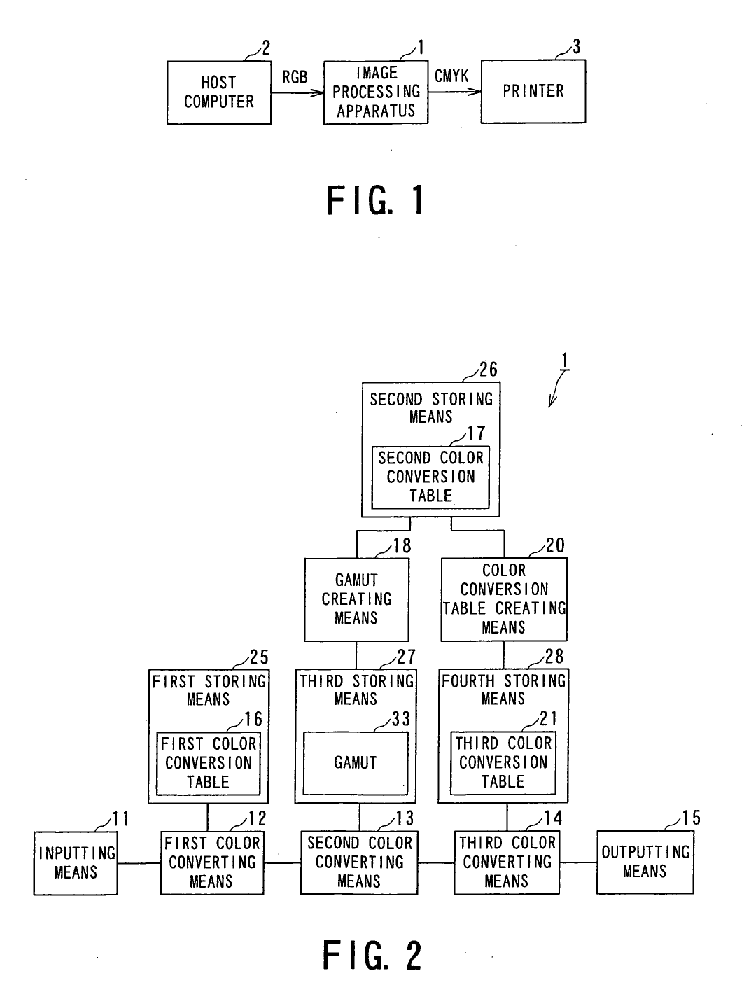

FIG. 1 is a schematic block diagram of a printing system including an image processing apparatus in accordance with the invention.

An image processing apparatus 1 is connected between a host computer 2 and a printer 3.

Image data including data such as RGB is inputted to the image processing apparatus 1 from the host computer 2. The image data including data such as RGB, which is inputted to the image processing apparatus 1, is converted into a color in a color space expressed in a color material such as CMYK suitable for printing in the printer 3 in the image processing apparatus 1.

FIG. 2 is a functional block diagram of an image processing apparatus in accordance with the invention.

In the image processing apparatus 1, an inputting means 11 is connected to a first color converting means 12 to which a second color converting means 13 and a first storing means 25 capable of storing a first color conversion table 16. The second color converting means 13 is connected to a third color converting means 14 and a third storing means 27 capable of storing a gamut 33. The third color converting means 14 is connected to an outputting means 15 and a fourth storing means 28 capable of storing a third color conversion table 21.

The third storing means 27 is connected to a gamut creating means 18 to which a second storing means 26 capable of storing a second color conversion table 17.

The fourth storing means 28 is connected to a color conversion table creating means 20 to which the second storing means 26 capable of storing the second color conversion table 17.

The second storing means 26 capable of storing the second color conversion table 17 is thus connected to the gamut creating means 18 and the color conversion table creating means 20.

As the inputting means 11, used is what is capable of inputting image data expressed in RGB or the like. The inputted image data inputted from the inputting means 11 is expressed in a color space such as sRGB, AppleRGB and AdobeRGB.

Each color space such as sRGB, AppleRGB and AdobeRGB includes a color space in original size and shape different from CIELAB and the like. Accordingly, the color space included in the inputted image data is formed dependently on the inputted image. The color space is referred to as a first color space hereinafter.

The first color conversion table 16 is a table in which a relation in conversion from a color in the first color space formed dependently on the inputted image to a color in a second color space formed independently of devices is recorded.

The second color space formed independently of devices in the above context is a general color space formed independently of devices such as a printer, that is, a color space expressed in a format such as CIELAB, for example.

The CIELAB color space is originally a space having limitation of a value L and no limitation of values a and b. The second color space is generally a space in the shape of a rectangular parallelepiped in which the maximum and minimum values are set for all of the values L, a and b due to the ICC profile format or the like. The second color space is a gathering of data of points (grid points) provided at equal intervals in the space in the shape of a rectangular parallelepiped. Concretely, the second color space is a space in the shape of a rectangular parallelepiped in which the value L is 0 to 100, the value a is −128 to 127 and the value b is −128 to 127.

The first color conversion table 16 is a table showing a relation in conversion from a value in RGB to a value in CIELAB, for example. The first color conversion table 16 may be data showing a relation determined on the basis of measurement or data showing a relation determined as a standard.

The first color conversion table 16 may be a table for a matrix operation or data for an interpolating calculation.

The first color conversion table 16 can be stored in the first storing means 25. The first color conversion table 16, however, is not necessarily stored in advance in the first storing means 25 since it is sometimes attached to inputted image data in transmitting an inputted image.

The first color conversion table 16 is not limited to one but may be created or held for every color space included in an inputted image. For example, it is possible to create or hold a table showing a relation in conversion from a value in sRGB to a value in CIELAB, a table showing a relation in conversion from a value in AppleRGB to a value in CIELAB or a table showing a relation in conversion from a value in AdobeRGB to a value in CIELAB in addition to a table showing a relation in conversion from a value in RGB to a value in CIELAB.

The second color conversion table 17 is a table in which a relation in conversion from a color in the third color space formed dependently on the output device 15 to a color in the second color space is recorded.

The third color space formed dependently on the output device 15 in the above context is a color space set for every device such as a printer and expressed in a format such as CMYK for a color material in the output device 15, for example.

The second color conversion table 17 is a table showing a relation in conversion from the quantity in CMYK to a value in CIELAB, for example. In the second color conversion table 17, recorded is a relation in conversion from the third color space formed dependently on the output device 15 to a color in the second color space. Accordingly, the second color conversion table 17 is a table showing a relation determined in advance in accordance with the kind of the output device (outputting device) 15.

The first color conversion means 12 converts a color in the first color space into a color in the second color space formed independently of devices on the basis of the first color conversion table 16.

The first color conversion means 12 performs a process of converting a value in RGB into a value in CIELAB, for example. A concrete example of a case that a converting process by the first color conversion means 12 is carried out on the basis of the first color conversion table 16 for a matrix calculation is shown below.

$$\begin{matrix}{L}^{*} = {A11}^{*} {R}^{2} + {A12}^{*} {G}^{2} + {A13}^{*} {B}^{2} + {A14}^{*} {R}^{*} G + {A15}^{*} {R}^{*} B + {A16}^{*} {G}^{*} B + {A17}^{*} R + {A18}^{*} G + {A19}^{*} B + A10 … & ( 1 ) \\ {a}^{*} = {A21}^{*} {R}^{2} + {A22}^{*} {G}^{2} + {A23}^{*} {B}^{2} + {A24}^{*} {R}^{*} G + {A25}^{*} {R}^{*} B + {A26}^{*} {G}^{*} B + {A27}^{*} R + {A28}^{*} G + {A29}^{*} b + A20 … & ( 2 ) \\ {b}^{*} = {A31}^{*} {R}^{2} + {A32}^{*} {G}^{2} + {A33}^{*} {B}^{2} + {A34}^{*} {R}^{*} G + {A35}^{*} {R}^{*} B + {A36}^{*} {G}^{*} B + {A37}^{*} R + {A38}^{*} G + {A39}^{*} B + A30 … & ( 3 )\end{matrix}$$

Values from A10 to A39 are converted from values in RGB to values in CIELAB by means of the first color converting means 12 in accordance with the formulas (1) to (3).

The gamut creating means 18 creates the gamut 33 of the output device 15 in the second color space on the basis of the second color conversion table 17. The gamut means a color space where the output device 15 can perform printing.

In the case that the second color conversion table 17 is a table showing a relation in conversion from quantity in CMYK to a value in CIELAB, for example, the gamut creating means 18 extract a value in CIELAB, which is obtained under a condition of a plurality of k=0, and a value of CIELAB, which is obtained under a condition that, for each K, any of C, M and Y is 100% while any of C, M and Y is 0%. This allows points on a surface of the color space capable of reproducing by means of a printer to be extracted so that the gamut 33 is created. It may be also possible to carry out an interpolating calculation with spline interpolation or the like on the basis of the extracted points on the surface to create the gamut 33 having more detailed data.

The second color converting means 26 converts a color in the second color space to a color in the gamut 33 in accordance with a gamut mapping using the gamut 33.

In the case that a color of image data inputted to the second color converting means 26 does not exist in the gamut 33 but exists outside the gamut 33, extracted is a color, which is closest to the color of inputted image data existing outside the gamut 33, among colors existing in the gamut 33 to output the extracted color instead of the color of the inputted image data as a value in CIELAB, for example.

The relation between the second color space and the gamut will be described with reference to the drawings.

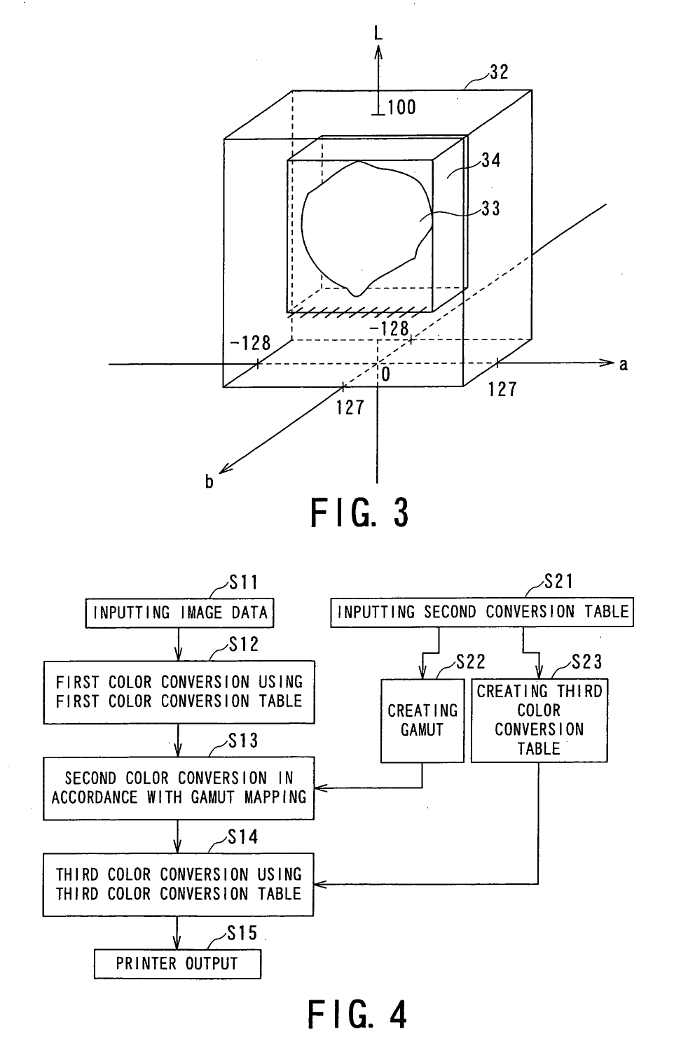

FIG. 3 is a perspective view illustrating an example of a relation of plural color spaces existing in a color space formed independently of devices.

FIG. 3 shows an example in which the color space 32 formed independently of devices and the gamut 33 are formed in the CIELAB color space.

The second color space 32 is a space in the shape of a rectangular parallelepiped, in which the value L is 0 to 100, the value a is −128 to 127 and the value b is −128 to 127, based on the ICC profile format or the like. The second color space 32 is a gathering of data of points (grid points) provided at equal intervals in the space in the shape of a rectangular parallelepiped.

In the gamut 33, the CMYK color space and the CIELAB color space are in a nonlinear relation. Accordingly, the CIELAB color space is not in the shape of a rectangular parallepiped but in a three-dimensional allo-shape. The gamut 33 is typically around over 10% of the second color space 32 in size and included in the second color space 32.

The color conversion table creating means 20 creates the third color conversion table 21.

The second color conversion table 17 is reversely converted to create the third color conversion table 21 in which a relation in conversion from a color in the second color space 32 to a color in the third color space is recorded.

In the case that the second color conversion table 17 is a table showing a relation in conversion from quantity in CMYK to a value in CIELAB, for example, the third color conversion table 21 is a table showing a relation in conversion from a value in CIELAB to quantity in CMYK.

The third color conversion table 21, however, is not necessarily a conversion table completely reverse to the second color conversion table 17. That is to say, in the case that the second color conversion table 17 shows a relation in conversion from quantity in CMYK to a value in CIELAB, for example, defining the quantity in CMYK allows LAB to be defined into one since an input having a value of 4 in quantity in CMYK corresponds to an output having a value of 3 in LAB in the second color conversion table 17 while the quantity in CMYK cannot be defined into one since an input having a value of 3 in LAB corresponds to an output having a value of 4 in quantity in CMYK in the third color conversion table 21.

In this case, properly defining the quantity of K for every CMY, for example, to make an input having a value of 3 in LAB corresponds to an output having a value of 3 in quantity in CMY in the third color conversion table 21 allows a relation between the value in LAB and the quantity in CMYK to be calculated.

The third color conversion table 21 is a table in the shape of a rectangular parallelepiped including the gamut 33 so that an outer surface of the gamut 33 would inscribe the rectangular parallelepiped, the table including a fourth color space formed independently of devices.

The fourth color space is a space in the shape of a rectangular parallelepiped in which the maximum and minimum values are set for all of the values L, a and b. The fourth color space is a gathering of data of points (grid points) provided at equal intervals in the space in the shape of a rectangular parallelepiped. The fourth color space is a color space in the shape of a rectangular parallelepiped including the gamut 33 so that an outer surface of the gamut 33 would inscribe the rectangular parallelepiped. Accordingly, the fourth color space is formed so as to be smaller than the second color space 32 and included in the second color space 32.

A relation among the fourth color space, the second color space and the gamut will be described with reference to FIG. 3.

As shown in FIG. 3, the fourth color space 34 is included in the second color space 32. The fourth color space 34 includes the gamut 33 so that an outer surface of the gamut 33 would inscribe a boundary surface of the fourth color space 34.

An example of a method of forming the third color conversion table 21 in the fourth color space 34 in the case that the second color conversion table 17 is a table having a record of a relation in conversion from quantity in CMYK to a value of CIELAB will be described hereinafter.

First, the respective maximum and minimum values of L*, a* and b*, namely, Lmax, Lmin, amax, amin, bmax and bmin are extracted from the second color conversion table 17.

The CIELAB space is then divided into equal intervals by means of respective axes with Lmax, amax and bmax corresponding to the maximum grid points of the respective axes and with Lmin, amin and bmin corresponding to the minimum grid points of the respective axes to obtain values in CIELAB for the respective grid points.

An error minimum square approximation method is used to obtain the following formulas in accordance with the second color conversion table 17.

$$\begin{matrix}C = {A11}^{*} {L}^{2} + {A12}^{*} {a}^{2} + {A13}^{*} {b}^{2} + {A14}^{*} {L}^{*} a + {A15}^{*} {L}^{*} b + {A16}^{*} {a}^{*} b + {A17}^{*} L + {A18}^{*} a + {A19}^{*} b + A10 + {A1a}^{*} {K}^{2} + {A1b}^{*} {K}^{*} L + {A1c}^{*} {K}^{*} a + {A1d}^{*} {K}^{*} b + {A1e}^{*} K … & ( 4 ) \\ M = {A21}^{*} {L}^{2} + {A22}^{*} {a}^{2} + {A23}^{*} {b}^{2} + {A24}^{*} {L}^{*} a + {A25}^{*} {L}^{*} b + {A26}^{*} {a}^{*} b + {A27}^{*} L + {A28}^{*} a + {A29}^{*} b + A20 + {A2a}^{*} {K}^{2} + {A2b}^{*} {K}^{*} L + {A2c}^{*} {K}^{*} a + {A2d}^{*} {K}^{*} b + {A2e}^{*} K … & ( 5 ) \\ Y = {A31}^{*} {L}^{2} + {A32}^{*} {a}^{2} + {A33}^{*} {b}^{2} + {A34}^{*} {L}^{*} a + {A35}^{*} {L}^{*} b + {A36}^{*} {a}^{*} b + {A37}^{*} L + {A38}^{*} a + {A39}^{*} b + A30 + {A3a}^{*} {K}^{2} + {A3b}^{*} {K}^{*} L + {A3c}^{*} {K}^{*} a + {A3d}^{*} {K}^{*} b + {A3e}^{*} K … & ( 6 )\end{matrix}$$

Values in CIELAB of the respective grid points and the value of K are substituted for the formulas (4) to (6).

The value of K is calculated by means of the following formulas since it correlates with brightness and saturation.

if L>50,

K=0; (7)

else if sqrt (a²+b²)>20

K=0; (8)

else

K=((50−Lmin)−(L−Lmin))/(50−Lmin)*(1−sqrt (a²+b²)/20)(wherein K is 0 to 100) (9)

This allows only a range of the fourth color space 34 in the shape of a rectangular parallelepiped circumscribing the gamut 33 formed in the output device 15 to be formed into a table as shown in FIG. 3. The above way of calculation for obtaining K is just an example. A way of preparing a table in which a value of K in a predetermined color space in the CIELAB color space is determined in advance to obtain K by means of an interpolating calculation or the like may be also applied.

The third color converting means 14 converts a color in the gamut 33 included in the fourth color space 34 into a color in the third color space on the basis of the third color conversion table 21.

An example of a process of converting a value in CIELAB into quantity in CMYK in the case that the third color conversion table 21 is a table showing a relation in conversion from a value in CIELAB to quantity in CMYK, that is, the case that the third color conversion table 21 is a table showing a relation in conversion from a value in CIELAB in a range of the fourth color space 34 to quantity in CMYK will be described.

First, the following eight table data enclosing pixels Li, ai and bi of an image to be converted in the first color space of data in the table are extracted for the pixels.

L0, a0, b0: C0, M0, Y0, K0 (10)

L0, a0, b1: C1, M1, Y1, K1 (11)

L0, a1, b0: C2, M2, Y2, K2 (12)

L0, a1, b1: C3, M3, Y3, K3 (13)

L1, a0, b0: C4, M4, Y4, K4 (14)

L1, a0, b1: C5, M5, Y5, K5 (15)

L1, a1, b0: C6, M6, Y6, K6 (16)

L1, a1, b1: C7, M7, Y7, K7 (17)

wherein L0<Li<L1, a0<ai<a1, b0<bi<b1 (18)

Then, the following interpolating calculations based on linear conversion in accordance with the number of dimensions of the color spaces of the eight table data are carried out to convert a value in CIELAB into quantity in CMYK.

$$\begin{matrix}Co = C0 + ( C1 - C0 ) * ( bi - b0 ) / ( b1 - b0 ) + ( C2 - C0 ) * ( ai - a0 ) / ( a1 - a0 ) + ( C4 - C0 ) * ( Li - L0 ) / ( L1 - L0 ) + ( C3 - C2 - C1 + C0 ) * ( ai - a0 ) / ( a1 - a0 ) * ( bi - b0 ) / ( b1 - b0 ) + ( C5 - C4 - C1 + C0 ) * ( Li - L0 ) / ( L1 - L0 ) * ( bi - b0 ) / ( b1 - b0 ) + ( C6 - C4 - C2 + C0 ) * ( Li - L0 ) / ( L1 - L0 ) * ( ai - a0 ) / ( a1 - a0 ) + ( C7 - C6 - C5 - C3 + C1 + C4 + C2 - C0 ) * ( Li - L0 ) / ( L1 - L0 ) * ( ai - a0 ) / ( a1 - a0 ) * ( bi - b0 ) / ( b1 - b0 ) … & ( 19 ) \\ Mo = M0 + ( M1 - M0 ) * ( bi - b0 ) / ( b1 - b0 ) + ( M2 - M0 ) * ( ai - a0 ) / ( a1 - a0 ) + ( M4 - M0 ) * ( Li - L0 ) / ( L1 - L0 ) + ( M3 - M2 - M1 + M0 ) * ( ai - a0 ) / ( a1 - a0 ) * ( bi - b0 ) / ( b1 - b0 ) + ( M5 - M4 - M1 + M0 ) * ( Li - L0 ) / ( L1 - L0 ) * ( bi - b0 ) / ( b1 - b0 ) + ( M6 - M4 - M2 + M0 ) * ( Li - L0 ) / ( L1 - L0 ) * ( ai - a0 ) / ( a1 - a0 ) + ( M7 - M6 - M5 - M3 + M1 + M4 + M2 - M0 ) * ( Li - L0 ) / ( L1 - L0 ) * ( ai - a0 ) / ( a1 - a0 ) * ( bi - b0 ) / ( b1 - b0 ) … & ( 20 ) \\ Yo = Y0 + ( Y1 - Y0 ) * ( bi - b0 ) / ( b1 - b0 ) + ( Y2 - Y0 ) * ( ai - a0 ) / ( a1 - a0 ) + ( Y4 - Y0 ) * ( Li - L0 ) / ( L1 - L0 ) + ( Y3 - Y2 - Y1 + Y0 ) * ( ai - a0 ) / ( a1 - a0 ) * ( bi - b0 ) / ( b1 - b0 ) + ( Y5 - Y4 - Y1 + Y0 ) * ( Li - L0 ) / ( L1 - L0 ) * ( bi - b0 ) / ( b1 - b0 ) + ( Y6 - Y4 - Y2 + Y0 ) * ( Li - L0 ) / ( L1 - L0 ) * ( ai - a0 ) / ( a1 - a0 ) + ( Y7 - Y6 - Y5 - Y3 + Y1 + Y4 + Y2 - Y0 ) * ( Li - L0 ) / ( L1 - L0 ) * ( ai - a0 ) / ( a1 - a0 ) * ( bi - b0 ) / ( b1 - b0 ) … & ( 21 ) \\ Ko = K0 + ( K1 - K0 ) * ( bi - b0 ) / ( b1 - b0 ) + ( K2 - K0 ) * ( ai - a0 ) / ( a1 - a0 ) + ( K4 - K0 ) * ( Li - L0 ) / ( L1 - L0 ) + ( K3 - K2 - K1 + K0 ) * ( ai - a0 ) / ( a1 - a0 ) * ( bi - b0 ) / ( b1 - b0 ) + ( K5 - K4 - K1 + K0 ) * ( Li - L0 ) / ( L1 - L0 ) * ( bi - b0 ) / ( b1 - b0 ) + ( K6 - K4 - K2 + K0 ) * ( Li - L0 ) / ( L1 - L0 ) * ( ai - a0 ) / ( a1 - a0 ) + ( K7 - K6 - K5 - K3 + K1 + K4 + K2 - K0 ) * ( Li - L0 ) / ( L1 - L0 ) * ( ai - a0 ) / ( a1 - a0 ) * ( bi - b0 ) / ( b1 - b0 ) … & ( 22 )\end{matrix}$$

Now, an operation of the image processing apparatus 1 in accordance with the invention will be described. FIG. 4 is a flowchart showing an operation of the image processing apparatus 1 in accordance with the invention.

First, image data is inputted (S11). The image data is inputted by transmission of the image data from a host computer, for example. The first color conversion table 16 is typically attached to the inputted image, which is transmitted. Accordingly, the first color conversion table 16 attached to the inputted image can be used as it is in S12 carried out after the step S11. In the case of no first color conversion table 16 attached to the inputted image, the first color conversion table 16 prepared in a ROM in advance is used for a process in S12.

After S11, in the first color converting step, a color in the first color space is converted into a color in the second color space 32 on the basis of the first color conversion table 16 in which a relation in conversion from a color in the first color space formed dependently on an inputted image to a color in the second color space formed independently of devices is recorded (S12).

In the first color converting step, a process of converting a value in RGB into a value in CIELAB, for example, is carried out.

In the color conversion performed in the first color converting step, used is the attached first color conversion table 16 in the case that the first color conversion table 16 is attached to an inputted image and the first color conversion table 16 prepared in the ROM in advance in the case of no table attached to the inputted image.

After S12, in a second color converting step, a color in the second color space 32 is converted into a color in the gamut 33 in accordance with gamut mapping using the gamut 33 (S13).

In the second color converting step, in the case that the second color space 32 is the CIELAB space, for example, a gathering of data of points (grid points) provided at equal intervals in the second color space 32 in the same CIELAB space is put in the gamut 33 smaller than the second color space 32 to form a dense gathering of data in the gamut 33.

After S13, in a third color converting step, a color in the gamut 33 included in the fourth color spaced 34 is converted into a color in the third color space on the basis of the third color conversion table 21 (S14).

In the third color converting step, in the case that the fourth color space 34 is the CIELAB space and the third color space is the CMYK space, for example, performed is a process of converting a value in CIELAB into quantity in CMYK.

After S14, the image data is outputted by means of a printer (S15).

Both of the gamut 33 used in the second color converting step (S13) and the third color conversion table 21 used in the third color converting step (S14) are created on the basis of the second color conversion table 17.

A process of creating the gamut 33 and the third color conversion table 21 on the basis of the second color conversion table 17 will be described with reference to FIG. 4.

First, the second color conversion table 17 is inputted (S21). The input is usually processed in accordance with the second color conversion table 17 stored in the ROM in advance.

After S21, in a gamut creating step, the gamut 33 of an output device is created in the second color space 32 on the basis of the second color conversion table 17 in which a relation in conversion from a color in the third color space formed dependently on the output device to a color in the second color space 32 is recorded (S22).

The gamut 33 created in S22 is used in the second color converting step (S13).

After S21, in a color conversion table creating step, created is the third color conversion table 21, which is created by reversely converting the second color conversion table 17, in which a relation in conversion from a color in the second color space 32 to a color in the third color space is recorded and which includes a fourth color space 34 in the shape of a rectangular parallelepiped including the gamut 33 so that an outer surface of the gamut 33 would inscribe the rectangular parallelepiped, the fourth color space 34 being formed independently of devices (S23).

The third color conversion table 21 created in S23 is used in the third color converting step (S14).

An effect of the image processing apparatus and the image processing method in accordance with the invention will be described.

In the image processing apparatus and the image processing method in accordance with the invention, the third color conversion table is a color conversion table including more relations between an input signal and an output signal than those of the conventional color conversion table, so that accuracy in color conversion is improved.

What is claimed is:

1. An image processing apparatus comprising:
a first color conversion table in which a relation in conversion from a color in a first color space formed dependently on an inputted image to a color in a second color space formed independently of devices is recorded;
a second color conversion table in which a relation in conversion from a color in a third color space formed dependently on an output device to a color in the second color space is recorded;
a first color converting means for converting a color in the first color space into a color in the second color space on the basis of the first color conversion table;
a gamut creating means for creating a gamut of the output device in the second color space on the basis of the second color conversion table;
a second color converting means for converting a color in the second color space into a color in the gamut in accordance with gamut mapping using the gamut;
a color conversion table creating means for creating a third color conversion table created by reversely converting the second color conversion table, the third color conversion table wherein a relation in conversion from a color in the second color space to a color in the third color space is recorded, the third color conversion table including a fourth color space in the shape of a rectangular parallelepiped including the gamut so that an outer surface of the gamut would inscribe the rectangular parallelepiped, the fourth color space being formed independently of devices; and
a third color converting means for converting a color in the gamut included in the fourth color space into a color in the third color space on the basis of the third color conversion table.

2. The image processing apparatus according to claim 1, wherein
the second color space is a CIELAB space.

3. An image processing method comprising:
a first color converting step for converting, on the basis of a first color conversion table in which a relation in conversion from a color in a first color space formed dependently on an inputted image to a color in a second color space formed independently of devices is recorded, a color in the first color space into a color in the second color space;
a gamut creating step for creating, on the basis of a second color conversion table in which a relation in conversion from a color in a third color space formed dependently on an output device to a color in the second color space is recorded, a gamut of the output device in the second color space;
a second color converting step for converting a color in the second color space into a color in the gamut in accordance with gamut mapping using the gamut;
a color conversion table creating step for creating a third color conversion table created by reversely converting the second color conversion table, the third color conversion table wherein a relation in conversion from a color in the second color space to a color in the third color space is recorded, the third color conversion table including a fourth color space in the shape of a rectangular parallelepiped including the gamut so that an outer surface of the gamut would inscribe the rectangular parallelepiped, the fourth color space being formed independently of devices; and
a third color converting step for converting a color in the gamut included in the fourth color space into a color in the third color space on the basis of the third color conversion table.

4. The image processing method according to claim 3, wherein
the second color space is a CIELAB space.
